(19) United States
(12) Patent Application Publication
(10) Pub. No.: US 2014/0293064 A1
(43) Pub. Date: Oct. 2, 2014

(54) IMAGE PICKUP APPARATUS

(71) Applicant: CANON KABUSHIKI KAISHA, Tokyo (JP)

(72) Inventor: Tetsuya Kimura, Asaka-shi (JP)

(73) Assignee: CANON KABUSHIKI KAISHA, Tokyo (JP)

(21) Appl. No.: 14/197,768

(22) Filed: Mar. 5, 2014

(30) Foreign Application Priority Data
Mar. 29, 2013 (JP) 2013-073047

(51) Int. Cl. G01S 3/786

(52) U.S. Cl. CPC G01S 3/7864
USPC 348/169

(57) ABSTRACT

An image pickup apparatus capable of performing object recognition with accuracy even when an object image formed on a focusing screen becomes out of focus on a photometric sensor. A light flux of the object image formed on the focusing screen is captured by the photometric sensor through a variable photometric aperture, and object recognition is performed by an object recognition unit based on image information contained in photometric information output from the photometric sensor. If determined that the object recognition cannot be achieved based on an object recognition operation of the object recognition unit performed according to the image information, the variable photometric aperture is stopped down under the control of a photometric control unit.

### BACKGROUND OF THE INVENTION

1. Field of the Invention

The present invention relates to an image pickup apparatus capable of performing object recognition.

2. Description of the Related Art

In an image pickup apparatus such as a digital single-lens reflex camera, an object image formed on a focusing screen is captured by a photometric sensor (which is disposed near a pentagonal prism) via a photometric aperture and a photometric lens, and a brightness of the object image is measured by the photometric sensor to decide a proper exposure. It is also known to recognize a main object from an object image captured by the photometric sensor.

With regard to the object recognition, an object recognition device has been proposed that recognizes as amain object an object gazed through a view finder, and tracks the object based on information about a color or brightness of an image of the main object (see, Japanese Laid-open Patent Publication No. H05-053043).

To perform highly accurate object recognition e.g. face recognition, an image must be captured with high resolution by the photometric sensor. However, due to defocusing of a photographing lens caused by a focus detection error and/or due to environmental factors (such as a position adjustment deviation of the photometric sensor and deformations of components of a photometric system under a high temperature and high humidity environment), an object image formed on the focusing screen sometimes becomes out of focus on the photometric sensor. In that case, it becomes impossible for the photometric sensor to capture, with high resolution, the object image formed on the focusing screen.

In the case of no defocusing correction mechanism being provided as in the device disclosed in Japanese Laid-open Patent Publication No. H05-053043, if an object image formed on the focusing screen becomes out of focus on the photometric sensor due to various factors described above, the photometric sensor cannot capture with high resolution the object image. This makes it difficult to perform highly accurate object recognition.

### SUMMARY OF THE INVENTION

The present invention provides an image pickup apparatus capable of performing object recognition with accuracy even when an object image formed on a focusing screen becomes out of focus on a photometric sensor.

According to this invention, there is provided an image pickup apparatus comprising a photometric unit configured to collect a light flux of an object image formed on a focusing screen, configured to measure the collected light flux to obtain photometric information that includes brightness information and image information about the object image, and configured to output the photometric information, a variable photometric aperture disposed in an optical path along which a light flux from the focusing screen reaches the photometric unit, wherein the variable photometric aperture has a variable aperture diameter, a photometric control unit configured to control the variable photometric aperture, an object recognition unit configured to perform object recognition based on the image information output from the photometric unit, and a determination unit configured to determine whether object recognition can be achieved by the object recognition unit based on an object recognition operation performed by the object recognition unit, wherein in a case where the determination unit determines that object recognition cannot be achieved by the object recognition unit, the photometric control unit controls to stop down the variable photometric aperture.

With this invention, even when an object image formed on the focusing screen becomes out of focus on the photometric sensor, the object image can be captured with high resolution by the photometric sensor, and therefore highly accurate object recognition can be performed with stability.

Further features of the present invention will become apparent from the following description of exemplary embodiments with reference to the attached drawings.

### BRIEF DESCRIPTION OF THE DRAWINGS

FIG. 1 is a schematic section view of a digital single-lens reflex camera that is a first embodiment of an image pickup apparatus according to this invention;

FIG. 2 is a view showing an example construction of a photometric device mounted to the digital single-lens reflex camera shown in FIG. 1;

FIG. 3 is a block diagram showing an example electrical construction of the digital single-lens reflex camera shown in FIG. 1;

FIG. 4 is a perspective view showing a construction of a conventional photometric device;

FIG. 5A is a view showing a state where a variable photometric aperture of the photometric device shown in FIG. 2 is stopped down;

FIG. 5B is a view showing a state where the variable photometric aperture is opened;

FIG. 6A is a view showing a light flux entering the photometric device when the variable photometric aperture is in a stopped down state;

FIG. 6B is a view showing a light flux entering the photometric device when the variable photometric aperture is in an open state;

FIG. 7A is a view showing an image output from a photometric sensor of the photometric device in a state where focusing on the sensor is not achieved;

FIG. 7B is a view showing an image output from the photometric sensor in a state where focusing on the sensor is achieved;

FIGS. 8A and 8B are a flowchart showing an operation of the digital single-lens reflex camera shown in FIG. 1;

FIG. 9 is a flowchart showing an aperture value control process performed in step S208 of FIG. 8A;

FIG. 10 is a view showing a correction table stored with photometric value correction amounts corresponding to aperture values of the variable photometric aperture;

FIG. 11 is a flowchart showing an operation of a digital single-lens reflex camera that is an image pickup apparatus according to a second embodiment of this invention; and

FIG. 12 is a flowchart showing an aperture value control process performed in step S221 of FIG. 11.

### DESCRIPTION OF THE EMBODIMENTS

The present invention will now be described in detail below with reference to the drawings showing preferred embodiments thereof.

### First Embodiment

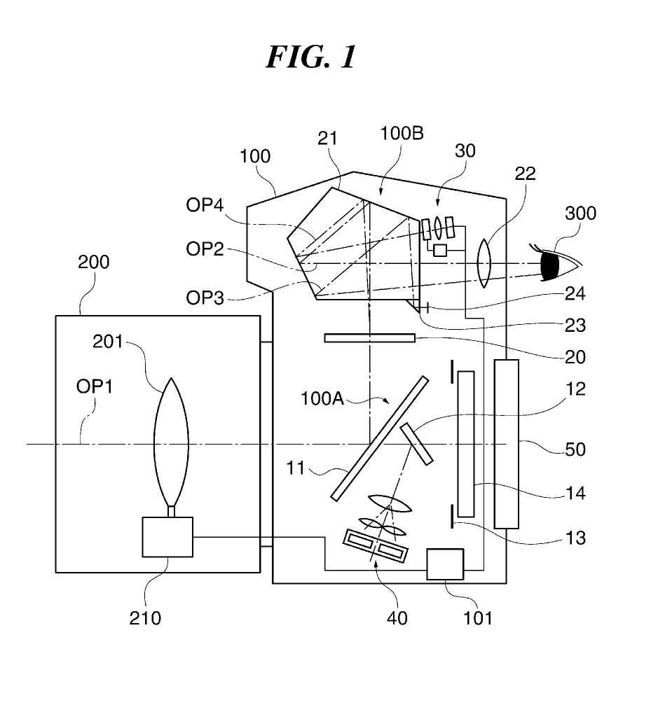

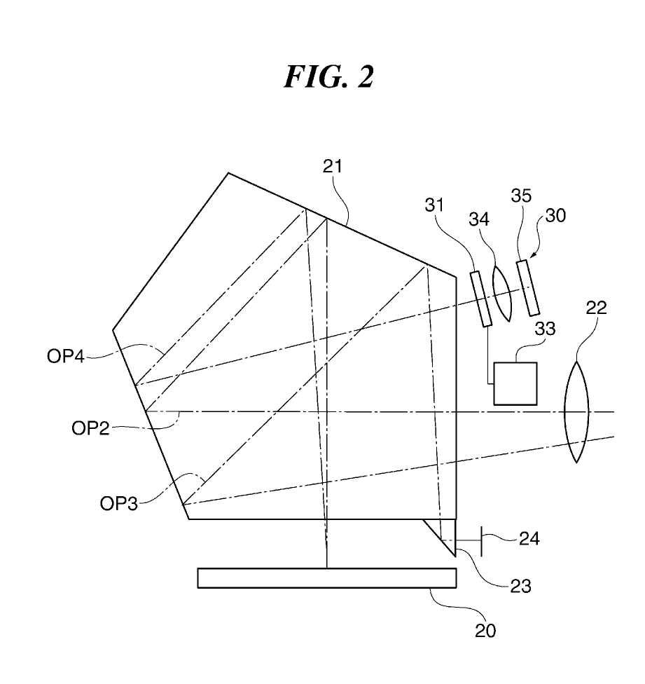

FIG. 1 schematically shows in section view a digital single-lens reflex camera that is first embodiment of an image pickup apparatus according to this invention, and FIG. 2 shows an example construction of a photometric device mounted to the digital single-lens reflex camera.

As shown in FIG. 1, the digital single-lens reflex camera (hereinafter, sometimes referred to as the camera) of this embodiment has a camera main unit 100 and a lens barrel 200 replaceably attached to the camera main unit 100. The camera main unit 100 has a mirror mechanism 100A, a finder optical system 100B, a photometric device 30, a focus detection device 40, a display device 50, a focal-plane shutter 13, an imaging element 14 (such as a CCD sensor or a CMOS sensor), a CPU 101, and the like. The lens barrel 200 has a lens group 201 for performing focusing and zooming, a lens driving device 210 for driving the lens group 201, an aperture device (not shown), etc.

The mirror mechanism 100A has a main mirror 11 constituted by a half mirror and a sub-mirror 12 supported for rotation relative to the main mirror 11. At the time of observation through a finder, i.e., when a release button (not shown) is half-pressed, the mirror mechanism 100A enters an object optical path OP1, i.e., it is brought into a mirror-down state shown in FIG. 1. At the time of photographing, i.e., when the release button is fully pressed, the mirror mechanism 100A retreats from the object optical path OP1, i.e., it is brought into a mirror-up state.

In the mirror-up state, the focal-plane shutter 13 is opened, and a light flux passing through the lens group 201 of the lens barrel 200 is guided along the object optical path OP1 to the imaging element 14.

The focal-plane shutter (hereinafter, referred to as the shutter) 13 has a magnet that when energized opens a front curtain and a magnet that when energized closes a rear curtain. A time period from the start of travel of the front curtain to the start of travel of the rear curtain of the shutter 13, i.e., shutter time, is controlled, whereby an amount of an object light flux collected by the lens group 201 is controlled. The object light flux is photoelectrically converted by the imaging element 14 into an object image. Image data after photoelectrical conversion is subjected to predetermined image processing. The resultant image data is recorded into a recording medium (not shown) and image-displayed on the display device 50.

On the other hand, in the mirror-down state, a light flux passing through the lens group 201 is guided along the object optical path OP1 to the main mirror 11 and split by the main mirror 11 into a light flux reflected upward and a light flux passing through the main mirror 11. The light flux reflected upward by the main mirror 11 is guided to the finder optical system 100B and image-formed on a focusing screen 20. The light flux passing through the main mirror 11 is reflected downward by the sub-mirror 12 and enters the focus detection device 40 (e.g., a TTL phase difference AF unit).

The finder optical system 100B has the focusing screen 20, a pentagonal prism 21, an eyepiece lens 22, a light guide prism 23, and an in-finder display device 24.

The focusing screen 20 is disposed at a position optically equivalent to a position where an imaging face of the imaging element 14 is disposed. A light flux from the focusing screen 20 is guided along a finder optical path OP2 to a photographer's eye 300 through the pentagonal prism 21 and the eyepiece lens 22.

The pentagonal prism 21 converts an object image formed on the focusing screen 20 into a normal upright image, thereby enabling a photographer to observe the object image with the eye 300 through the eyepiece lens 22.

The in-finder display device 24 displays various photographing information of the camera (such as an aperture value and a shutter speed) in the finder through the light guide prism 23, the pentagonal prism 21, and the eyepiece lens 22. A light flux from the in-finder display device 24 is guided to the photographer's eye 300 along an in-finder display optical path OP3.

As shown in FIG. 2, the photometric device 30 is disposed above the eyepiece lens 22, and has a variable photometric aperture 31, an aperture driving device 33, a photometric lens 34, and a photometric sensor 35. The variable photometric aperture 31 and the photometric lens 34 are disposed in a photometric optical path OP4 along which a light flux from the focusing screen 20 reaches the photometric sensor 35 via the pentagonal prism 21. The photometric optical path OP4 is different from the in-finder display optical path OP3.

A light flux guided along the photometric optical path OP4 from the focusing screen 20 to the photometric sensor 35 is reduced by the variable photometric aperture (hereinafter, sometimes referred to as the variable aperture) 31. At that time, the degree of reduction of the light flux can be changed by changing an aperture value of the variable aperture 31 by the aperture driving device 33.

The light flux reduced by the variable aperture 31 is image-formed on a chip surface of the photometric sensor 35 through the photometric lens 34. The photometric sensor 35 is constituted by an image sensor and capable of performing object recognition and object brightness detection based on an object image formed on the chip surface. It should be noted that the variable aperture 31, which will be described in detail later, may be any type of aperture such as a mechanically-driven aperture or a liquid crystal aperture that is capable of changing the aperture diameter (opening diameter).

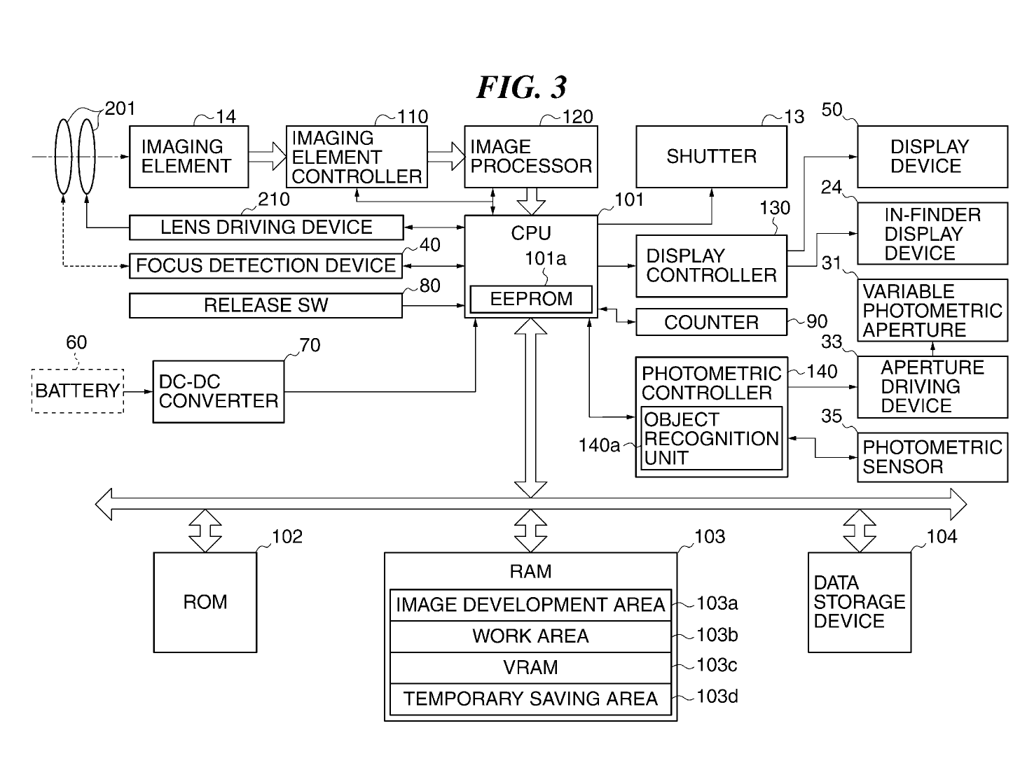

FIG. 3 shows in block diagram an example electrical construction of the digital single-lens reflex camera. As shown in FIG. 3, the CPU 101 has an EEPROM 101a, which is a nonvolatile memory. The CPU 101 is connected with a ROM 102, a RAM 103, a data storage device 104, a DC-DC converter 70, a release SW (switch) 80, an image processor 120, a display controller 130, and the like.

The ROM 102 is stored with control programs executed by the CPU 101. Based on control programs, the CPU 101 performs various processing that includes processing to read a photographic image signal output from the image processor 120 and transfer the image signal to the RAM 103, processing to transfer display data from the RAM 103 to the display controller 130, and processing to perform JPEG compression of image data and store the compressed data in file format into the data storage device 104.

The CPU 101 gives instructions for data capture and image processing to the imaging element 14, the imaging element controller 110, the image processor 120, and the display controller 130. The CPU 101 also gives an instruction for photographing in response to the release button being operated, and gives the DC-DC converter 70 a control signal for control of power supply to respective parts of the camera.

The image processor 120 performs image processing (such as gamma conversion, color space conversion, white balance, auto exposure, and flash correction) on a 10-bit digital signal output from the imaging element controller 110, and outputs a 8-bit digital signal of YUV 4:2:2 format.

The imaging element 14 is connected to the imaging element controller 110, and photoelectrically converts an object light flux passing through the lens group 201 and then formed on the imaging element 14 into an analog electrical signal. The imaging element controller 110 has a timing generator, a noise reduction/gain processing circuit, an A/D conversion circuit, and a pixel thinning circuit (none of which are shown).

The timing generator supplies the imaging element controller 110 with a transfer clock signal and a shutter signal. The noise reduction/gain processing circuit performs noise reduction and gain processing on an analog signal output from the imaging element 14. The A/D conversion circuit converts the analog signal into a 10-bit digital signal. The pixel thinning circuit performs pixel thinning processing according to a resolution conversion instruction supplied from the CPU 101.

The display controller 130 drives the display device 50 and the in-finder display device 24. The display device 50 displays (e.g. in color) an image picked up by the imaging element 14 and then vertically and horizontally thinned by the imaging element controller 110.

The display controller 130 receives YUV digital image data transferred from the image processor 120 or receives YUV digital image data obtained by JPEG decompression of an image file stored in the data storage device 104, and converts the received data into a RGB digital signal for output to the display device 50.

The focus detection device 40 has a pair of CCD line sensors for focus detection, performs A/D conversion of voltage signals obtained from the CCD line sensors, and transmits resultant digital signals to the CPU 101. The focus detection device 40 controls a light amount accumulation time in the CCD line sensors and performs AGC (auto gain control) according to instructions given from the CPU 101.

The RAM 103 has an image development area 103a, a work area 103b, a VRAM 103c, and a temporary saving area 103d. The image development area 103a is used as a temporary buffer for temporarily storing photographic image data (YUV digital signal) supplied from the image processor 120 and JPEG-compressed image data read from the data storage device 104, and also used as an image-dedicated work area for image compression and for image decompression. The work area 103b is an area used for execution of programs. The VRAM 103c is a memory for storing display data to be displayed on the display device 50. The temporary saving area 103d is an area in which various data is temporarily saved.

The data storage device 104 is for storing, in file format, photographic image data (which is JPEG-compressed by the CPU 101), attached data referred to by applications, etc. and is constituted by e.g. a flash memory.

The release SW 80 is for instructing start of a photographing operation, and has two-stage switch positions corresponding to the press of the release button. When a first-stage switch position where a switch SW1 is switched on is detected, camera settings (white balance, photometry, auto focusing, etc.) are locked. When a second-stage switch position where a switch SW2 is switched on is detected, an object field image signal is captured.

A photometric controller 140 performs photometric control. In the photometric control, according to instructions given by the CPU 101, the photometric controller 140 drivingly controls the photometric sensor 35, captures object field brightness signals generated in respective ones of photometric regions into which a photographic object field of the photometric sensor 35 is divided, and A/D converts the object field brightness signals into 8-bit digital signals.

The photometric controller 140 corrects the object field brightness signals (digital signals) with a value of F-number (effective F-number) that represents the brightness of the lens group 201, whereby variations in the object field brightness signals output from the photometric sensor 35 are corrected for level/gain adjustment. Furthermore, the photometric controller 140 corrects a photometric value based on e.g. lens information about the lens barrel 200, thereby obtaining object field brightness information.

Based on the object field brightness information, the CPU 101 calculates the camera's exposure and appropriately controls the shutter speed and the aperture of the lens barrel 200 to obtain an appropriate exposure.

To correct the photometric value, a variety of correction amounts are used according to photographing circumstances, camera settings state, type of lens barrel 200 attached to the camera, etc. These correction amounts are stored in the EEPROM 101a of the CPU 101.

An object recognition unit 140a of the photometric controller 140 performs object recognition in which by using a known method, a main object is recognized based on image information output from the photometric sensor 35. For example, a main object is recognized based on an amount of edge blur corresponding to a detected in-focus degree of object image. Alternatively, an object gazed through the finder can be recognized as a main object.

The photometric controller 140 also controls the aperture driving device 33 that drives the variable photometric aperture 31. Under the control of the photometric controller 140, the aperture driving device 33 operates to stop down the variable aperture 31 to a predetermined aperture value.

A battery 60 is a rechargeable secondary battery or a dry battery. The DC-DC converter 70 is supplied with power from the battery 60, steps up and regulates the supplied power to generate source voltages, and supplies the voltages to respective parts of the camera. In accordance with a control signal supplied from the CPU 101, the DC-DC converter 70 starts and stops the voltage supply.

According to an instruction given from the CPU 101, the lens driving device 210 drives the lens group 201 to focus on an object. According to an instruction of the CPU 101, the shutter 13 causes the shutter curtains to travel at the instructed shutter time, whereby the imaging element 14 is exposed to light. A counter 90 counts the number of times the photometric sensor 35 performs object recognition.

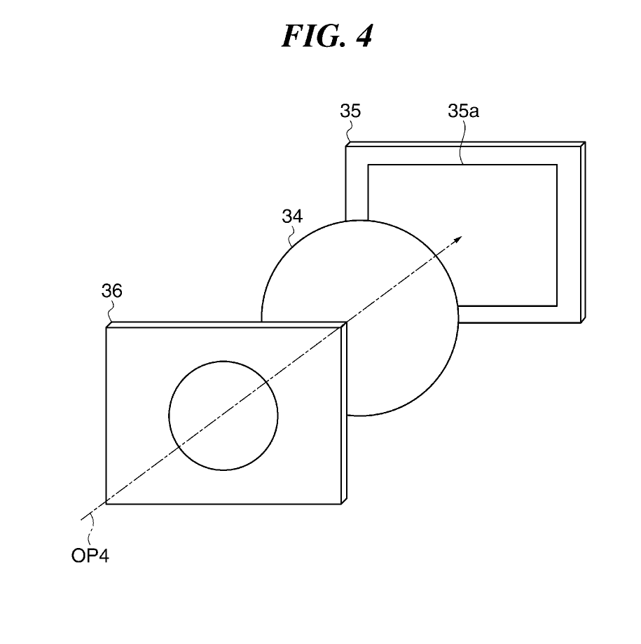

Next, with reference to FIGS. 4-7, a description will be given of the variable photometric aperture 31.

FIG. 4 shows in perspective view a construction of a conventional photometric device. In the conventional photometric device, a photometric light flux reduced by a photometric aperture 36 is collected by a photometric lens 34 and guided to a chip surface 35a of a photometric sensor 35. The photometric aperture 36 is formed by a molded member, a mask, and the like, and has a fixed aperture value. The fixed aperture value is decided according to a balance between a brightness lower limit and a spot photometric range of the photometric sensor 35.

On the contrary, the variable photometric aperture 31 of this embodiment is configured to have an arbitarily adjustable aperture value. In this embodiment, the variable aperture 31 has a mechanical aperture mechanism, but this is not limitative.

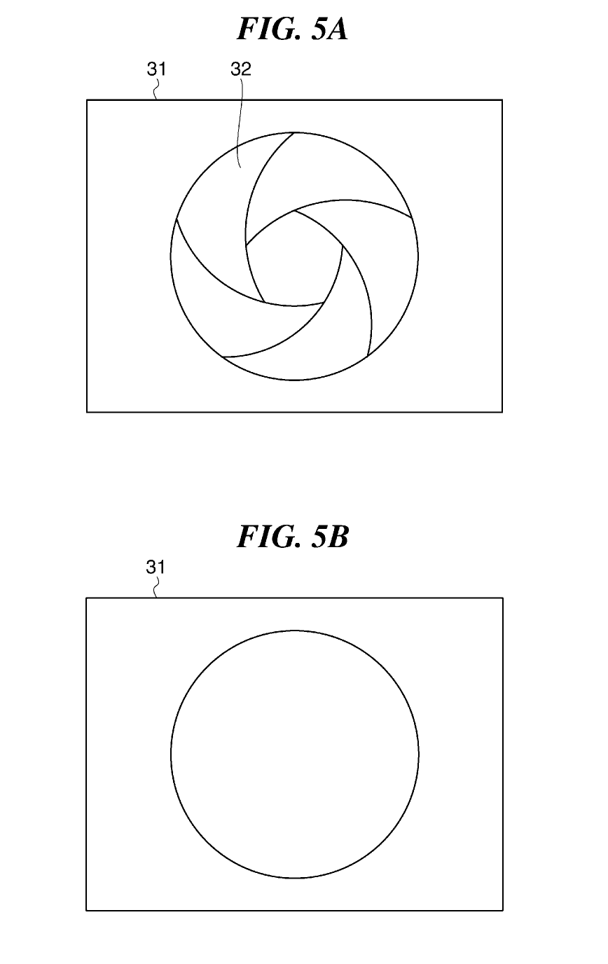

FIG. 5A shows a state where the variable aperture 31 is stopped down, and FIG. 5B shows a state where the variable aperture 31 is opened.

The variable aperture 31 has aperture blades 32 that define an opening of the aperture 31. When the variable aperture 31 is driven by the aperture driving device 33 between the open state of FIG. 5B and the stopped-down state of FIG. 5A, a diameter of the opening (aperture diameter) of the variable aperture 31 changes, thereby changing an aperture value of the variable aperture 31.

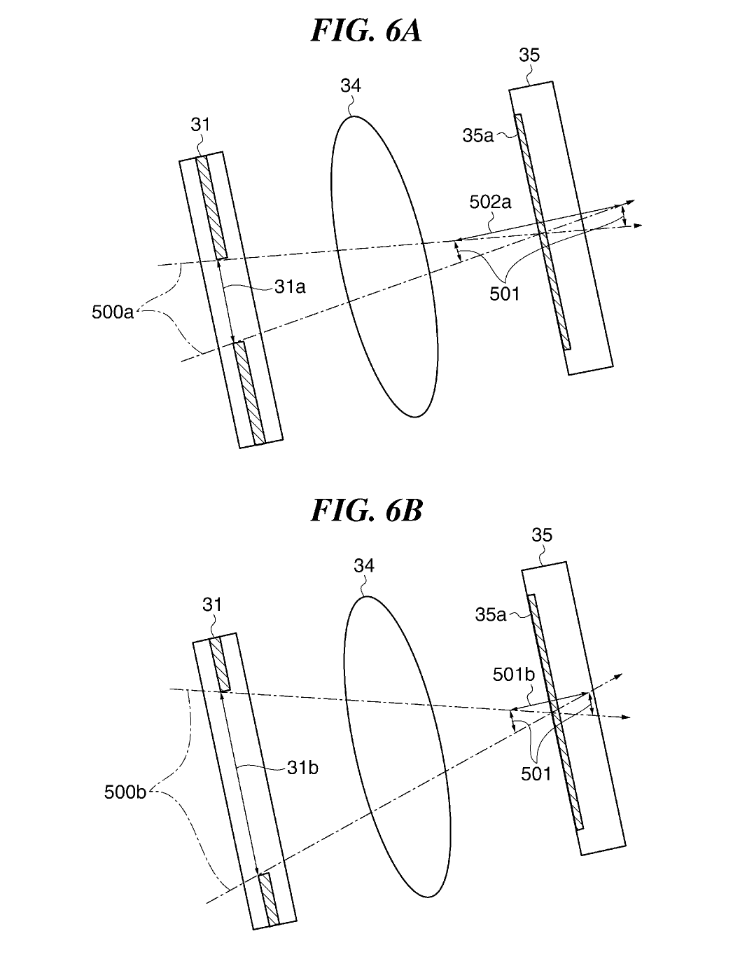

FIG. 6A shows a light flux 500a entering the photometric device 30 when the variable aperture 31 is in a stopped down state, and FIG. 6B shows a light flux 500b entering the photometric device 30 when the variable aperture 31 is in an open state.

In FIGS. 6A and 6B, reference numerals 31a, 31b each denote the aperture diameter of the variable aperture 31, which corresponds to the aperture value of the variable aperture 31 as already described above. An amount of light that reaches the chip surface 35a of the photometric sensor 35 varies according to the aperture value of the variable aperture 31. A brightness lower limit of the photometric sensor 35 is influenced by the aperture value.

In FIGS. 6A and 6B, reference numeral 501 denotes an allowable confusion circle diameter in the optical system. In a range (also called the depth of field) where a confusion circle diameter is smaller than the allowable confusion circle diameter 501, focusing is achieved in appearance.

A depth of field 502a obtained when the variable aperture 31 is stopped down as shown in FIG. 6A is deeper than a depth of field 502b obtained when the variable aperture 31 is opened as shown in FIG. 6B. In other words, the depth of field varies depending on the aperture value. When the variable aperture 31 is opened, the depth of field becomes shallower. When the variable aperture 31 is stopped down, the brightness lower limit decreases, but the depth of field becomes deeper.

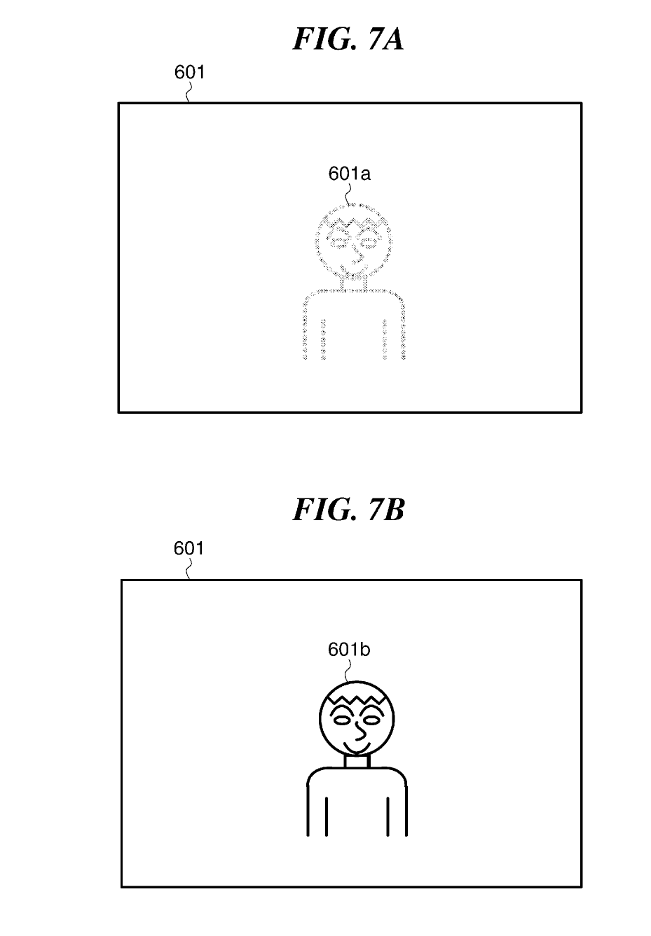

FIG. 7A shows an image output from the photometric sensor 35 in a state where focusing on the sensor is not achieved, and FIG. 7B shows an image output from the photometric sensor 35 in a state where focusing on the sensor is achieved.

In the example of FIG. 7A, an attempt is made to photograph an object 601a under e.g., a high temperature and high humidity environment in which components of the photometric device 30 are likely to be deformed, but focusing is not achieved. As a result, the resolution of the image 601 output from the photometric sensor 35 becomes low. In that case, edges of the object 601a cannot be extracted, and the CPU 101 cannot determine the object 601a as being a person. In other words, the object 601a cannot be recognized as a main object. If there are one or more background objects, the object 601a is more difficult to be discriminated from the background objects, and becomes more difficult to be recognized as a main object.

When the variable photometric aperture 31 is stopped down to deepen the depth of field, the in-focus range is broadened. In other words, the out-of-focus state of FIG. 7A is changed to the in-focus state of FIG. 7B. As a result, the required image resolution for object recognition can be ensured, so that edges of the image can be extracted. Accordingly, an object 601b shown in FIG. 7B can be determined as being a person and can be recognized as a main object by the CPU 101.

To realize highly accurate object recognition, an image must be captured with high resolution by the photometric sensor 35, as previously described. To that end, a focus adjustment of the photometric sensor 35 is performed. However, a complicated adjustment mechanism must be used in order to exactly position the photometric sensor 35 at an in-focus position.

In this embodiment, the focus adjustment is performed with an allowance by taking account of a variation of adjustment. More specifically, upon assembly and adjustment of the camera, the aperture value of the variable aperture 31 is set to a first aperture value that is decided in advance so as to balance the brightness lower limit and the depth of field of the photometric sensor 35. The first aperture value is a reference aperture value at the time of image capturing and an initial aperture value of the variable aperture 31.

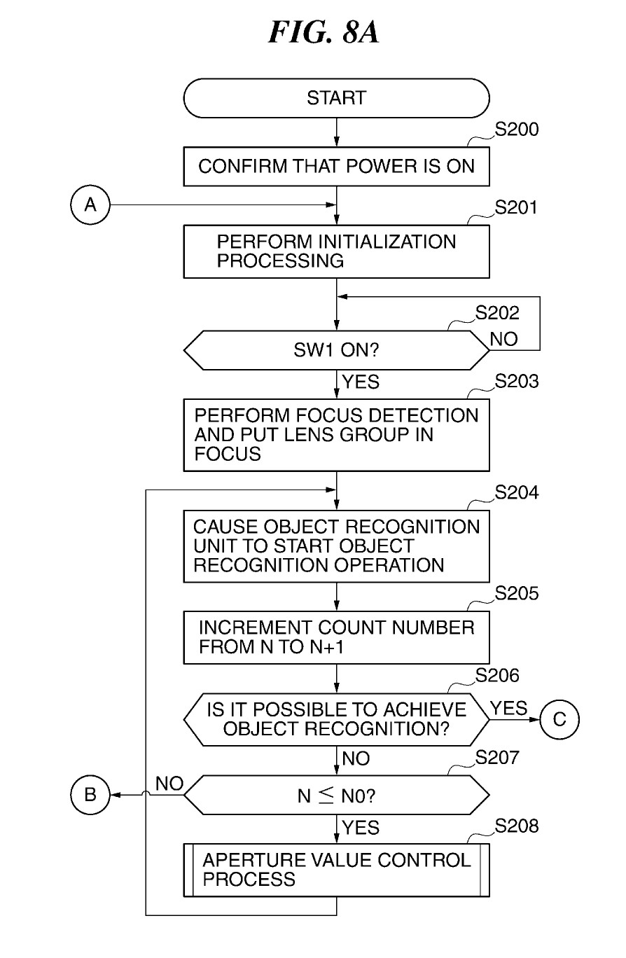

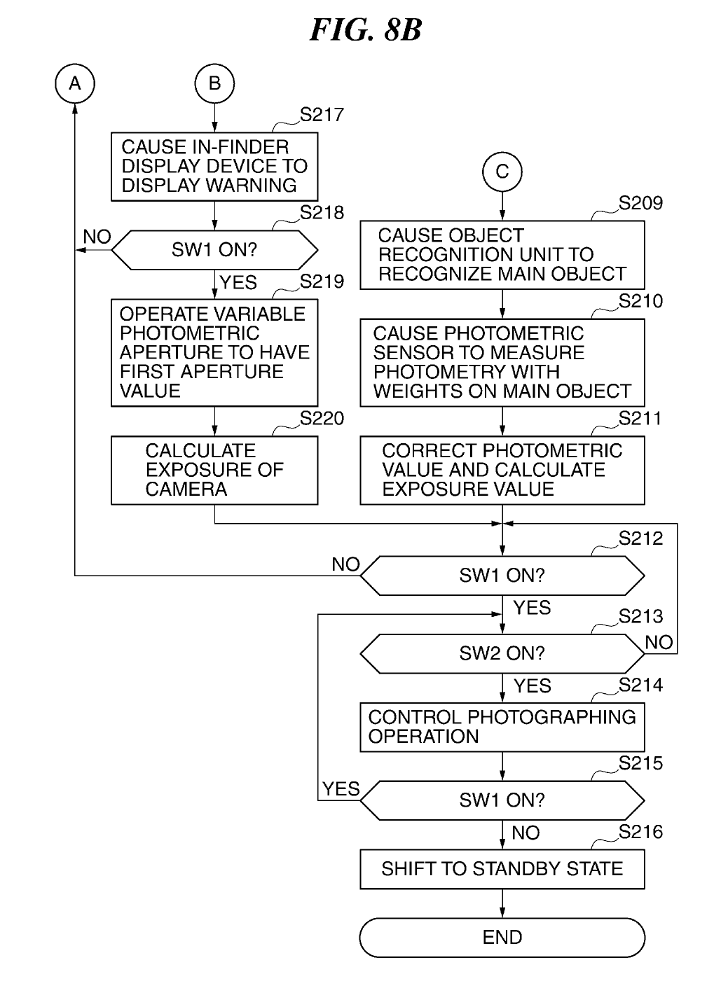

Next, with reference to FIGS. 8-10, a description will be given of operation of the digital single-lens reflex camera of this embodiment. FIGS. 8A and 8B show in flowchart an operation of the camera. To perform processing shown in FIGS. 8A and 8B, a control program loaded from the ROM 102 to the RAM 103 is executed by the CPU 101.

Referring to FIGS. 8A and 8B, the CPU 101 confirms that the power of the camera is on (step S200), and performs initialization processing where the variable aperture 31 is set to the first aperture value and the count number of the counter 90 is set to zero (step S201). Next, the CPU 101 determines whether the switch SW1 of the release SW 80 is on (step S202).

When the release button is operated by the user to switch the switch SW1 on (YES to step S202), the CPU 101 causes the focus detection device 40 to perform focus detection and causes the lens driving device 210 to drive the lens group 201 according to an output signal of the focus detection device 40, thereby achieving focusing (step S203).

Next, the CPU 101 controls the photometric controller 140 to cause the object recognition unit 140a to start an object recognition operation that is based on image information supplied from the photometric sensor 35 (step S204), and increments the count number N of the counter 90 by one (step S205). In step S206, the CPU 101 determines whether object recognition can be achieved based on the object recognition operation of the object recognition unit 140a started in step S204.

If the object recognition cannot be achieved (NO to step S206), the CPU 101 determines whether the count number N of the counter 90 is equal to or less than a predetermined number of times N₀ (step S207). If the answer to step S207 is YES, the CPU 101 performs an aperture value control process (described in detail later) in which the CPU 101 controls the photometric controller 140 to cause the aperture driving device 33 to operate the variable aperture 31 (step S208). Then, the process returns to step S204.

If the count number N of the counter 90 exceeds the predetermined number of times N₀ (NO to step S207), the CPU 101 controls the display controller 130 to cause the in-finder display device 24 to display a warning indicating that object recognition cannot be achieved (step S217), and determines whether the switch SW1 of the release SW 80 is on (step S218). If the switch SW1 is off (NO to step S218), the CPU 101 determines that photographing is not to be continued and returns to step S201.

If the switch SW1 is on (YES to step S218), the CPU 101 determines that photographing is to be continued, and controls the photometric controller 140 to cause the aperture driving device 33 to operate the variable aperture 31 to have the first aperture value (step S219). Then, the CPU 101 causes the photometric controller 140 to perform a photometric operation, calculates exposure of the camera based on a photometric result (step S220), and proceeds to step S212.

If the object recognition can be achieved based on the recognition operation of the object recognition unit 140a (YES to step S206), the CPU 101 causes the object recognition unit 140a to perform the object recognition (step S209), and controls the photometric controller 140 to cause the photometric sensor 35 to measure photometry with weights on a recognized main object (step S210).

Next, in step S211, the CPU 101 controls the photometric controller 140 to correct, as will be described in detail later, a photometric value (which is measured in step S210) with the aperture value of the variable aperture 31 determined in step S208, thereby obtaining object field brightness information. Based on the object field brightness information, the CPU 101 calculates exposure values (aperture value and shutter time) according to a predetermined photometric algorithm.

Next, the CPU 101 determines whether the switch SW1 of the release SW 80 is on (step S212). If the switch SW1 is off (NO to step S212), the process returns to step S201.

If the switch SW1 is on (YES to step S212), the CPU 101 determines whether the switch SW2 of the release SW 80 is on (step S213). If the switch SW2 is off (NO to step S213), the process returns to step S212.

If the switch SW2 is on (YES to step S213), the CPU 101 controls a photographing operation (step S214), and determines whether the switch SW1 is on (step S215). If the switch SW1 is on (YES to step S215), the CPU 101 determines that continuous photographing is to be performed and returns to step S213. If the switch SW1 is off (NO to step S215), the CPU 101 shifts to a standby state, i.e., a photographing preparation state (step S216), and completes the present process.

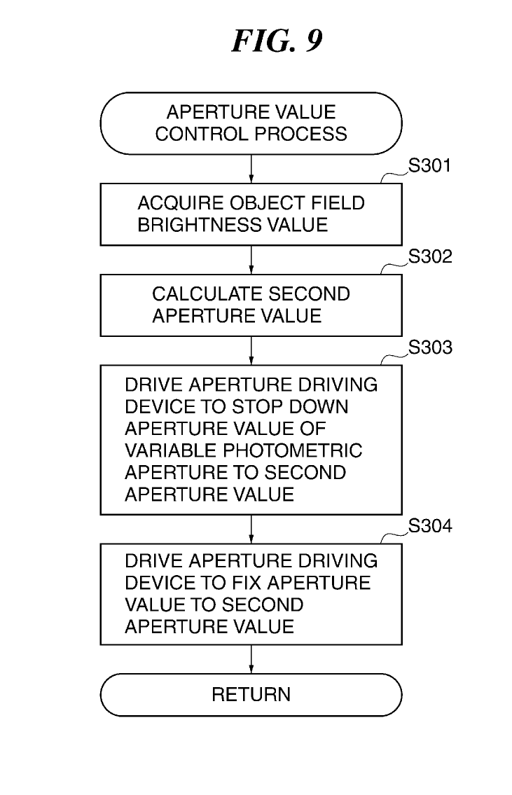

Next, with reference to FIG. 9, a description will be given of the aperture value control process performed in step S208 of FIG. 8A.

Referring to FIG. 9, the CPU 101 controls the photometric controller 140 to perform a known photometric operation, and acquires an object field brightness value measured by the photometric sensor 35 (step S301).

Next, based on the object field brightness value acquired in step S301, the CPU 101 calculates a second aperture value at which the variable aperture 31 is maximally stopped down in a photometry range where the brightness lower limit of the photometric sensor 35 is not exceeded, even if the variable aperture 31 is stopped down (step S302). To calculate the second aperture value, object field brightness values actually measured at various aperture values of the variable aperture 31 are input in advance to the camera. The CPU 101 calculates the second aperture value based on the object field brightness value acquired in step S301 with reference to the relation between actually measured brightness values and aperture values.

In steps S303 and S304, the CPU 101 controls the photometric controller 140 to drive the aperture driving device 33 to stop down the variable aperture 31 to the second aperture value calculated in step S302 and fix the aperture value of the variable aperture 31 to the second aperture value.

Next, a description will be given of how the photometric value is corrected in step S211 of FIG. 8B. In step S211, the photometric value obtained in step S210 of FIG. 8B is corrected.

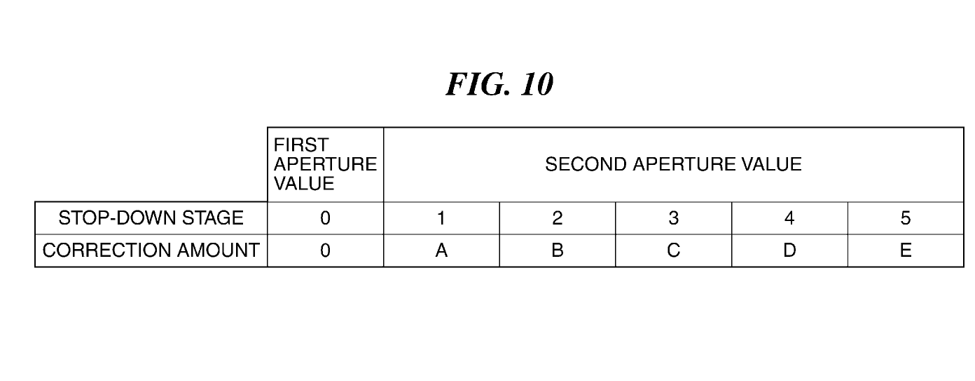

FIG. 10 shows a correction table stored with photometric value correction amounts corresponding to aperture values of the variable aperture 31. The correction table is stored in the EEPROM 101a of the CPU 101.

The correction table has a “first aperture value” field and a “second aperture values” field. The “first aperture value” field has one “stop-down stage” field stored with a value of 0 that represents a zero-th stop-down stage and one “correction amount” field stored with a correction amount of zero (i.e., no correction) corresponding to the zero-th stop-down stage. The “second aperture values” field has N “stop-down stage” fields stored with values of 1 to N representing first to N stop-down stages and N “correction amount” fields stored with correction amounts corresponding to the first to N stop-down stages. In the example of FIG. 10, N is 5 and correction amounts A-E correspond to the first to fifth stop-down stages.

When the variable aperture 31 is stopped down from the first aperture value (i.e., the zero-th stop-down stage) to any of the second aperture values (i.e., any of the first to fifth stop-down stages), the photometric controller 140 corrects the photometric value with a corresponding one of the correction amounts A-E. As a result, a proper exposure can be obtained, even if the variable aperture 31 is stopped down from the first aperture value to any of the second aperture values.

It should be noted that with the increasing degree of stop-down of the variable aperture 31, a light flux introduced into the photometric sensor 35 decreases. As a result, an amount of light received by the photometric sensor 35 decreases, and an amount of photometric correction becomes large. When the variable aperture 31 is stopped down, the degree of reduction of the light amount received by the photometric sensor 35 becomes larger at a peripheral part than at a central part of the photometric sensor 35, and therefore the photometric correction amount becomes larger at the peripheral part than at the central part of the photometric sensor 35.

As described above, in this embodiment, if determined that object recognition cannot be achieve, the second aperture value is calculated based on photometric information output from the photometric sensor 35, and the variable photometric aperture 31 is stopped down to the second aperture value to thereby deepen the depth of field.

As a result, even when an object image formed on the focusing screen 20 becomes out of focus on the photometric sensor 35 due to defocusing of the photographing lens caused by a focus detection error and/or due to various environmental factors previously described, an image can be captured with appropriate resolution by the photometric sensor 35. Accordingly, the object recognition can be performed with high accuracy and stability.

Furthermore, in this embodiment, the variable photometric aperture 31 is stopped down to the second aperture value based on photometric information output from the photometric sensor 35, whereby a time period required for the stop-down of the variable aperture 31 can be shortened.

### Second Embodiment

In the following, a description will be given of a digital single-lens reflex camera, which is an image pickup apparatus of a second embodiment of this invention. The camera of this embodiment is basically the same as that of the first embodiment, and a description of points common to these two embodiments will be omitted.

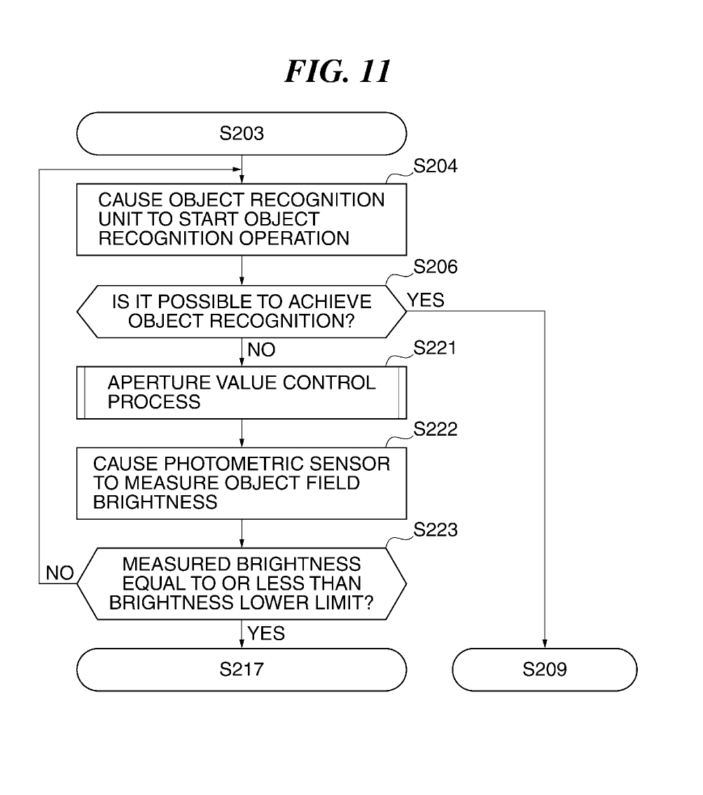

FIG. 11 shows in flowchart an essential part of operation (i.e., processing relating to object recognition and aperture value control process) of the camera of this embodiment.

The CPU 101 sequentially executes processing in steps S200-S203 of FIG. 8A. More specifically, the CPU 101 performs the initialization processing when the power is on, causes the focus detection device 40 to make a focus detection when the switch SW1 of the release switch 80 is on, and causes the lens driving device 210 to drive the lens group 201 according to an output signal of the focus detection device 40 to achieve focusing. Then, in step S204 corresponding to step S204 of FIG. 8A, the CPU 101 controls the photometric controller 140 to cause the object recognition unit 140a to start an object recognition operation based on image information output from the photometric sensor 35.

Next, in step S206, the CPU 101 determines whether object recognition can be achieved based on the object recognition operation started in step S204. If the object recognition can be achieved (YES to step S206), the CPU 101 sequentially executes processing shown in step S209 and in subsequent steps of FIG. 8B.

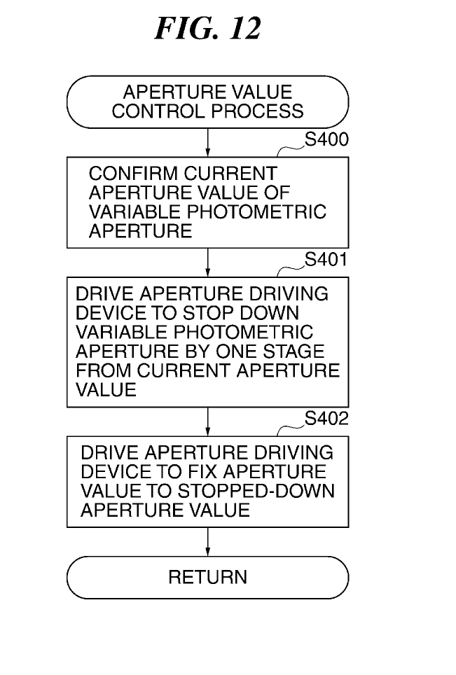

If the object recognition cannot be achieved based on the object recognition operation of the object recognition unit 140a (NO to step S206), the CPU 101 executes an aperture value control process different from that executed in step S208 of FIG. 8A (step S221), as will be described in detail later with reference to FIG. 12.

Next, the CPU 101 controls the photometric controller 140 to cause the photometric sensor 35 to perform a known photometric operation to measure an object field brightness (step S222), and determines whether a brightness of light received (measured) by the photometric sensor 35 is equal to or less than the brightness lower limit (step S223).

If the brightness of light received by the photometric sensor 35 becomes equal to or less than the brightness lower limit due to a stop-down of the variable aperture 31 in the aperture value control process in step S221 (YES to step S223), so that photometry becomes impossible, the CPU 101 sequentially executes processing shown in step S217 and in subsequent steps of FIG. 8B. If the brightness of light received (measured) by the photometric sensor 35 is neither equal to nor less than the brightness lower limit (NO to step S223) and photometry can be made, the process returns to step S204.

FIG. 12 shows in flowchart the aperture value control process performed in step S221 of FIG. 11.

Referring to FIG. 12, the CPU 101 confirms a current aperture value of the variable aperture 31 through the photometric controller 140 (step S400), and controls, in step S401, the photometric controller 140 to drive the aperture driving device 33 to stop down the variable aperture 31 by one stage from the current aperture value confirmed in step S400.

Ina case, for example, that the current aperture value confirmed in step S400 is the first aperture value corresponding to the zero-th stop-down stage shown in FIG. 10, the CPU 101 controls the aperture driving device 33 such that the aperture value of the variable aperture 31 becomes equal to an aperture value corresponding to the first stop-down stage. In another case where the current aperture value is an aperture value corresponding to the second stop-down stage, the CPU 101 controls the aperture driving device 33 such that the aperture value of the variable aperture 31 becomes equal to an aperture value corresponding to the third stop-down stage.

Next, in step S402, the CPU 101 controls the photometric controller 140 to fix the aperture value of the variable aperture 31 to the aperture value stopped down in step S401.

As described above, in this embodiment, if determined that object recognition cannot be achieved, the variable aperture 31 is stopped down stage by stage to deepen the depth of field. As a result, even when an object image formed on the focusing screen 20 becomes out of focus on the photometric sensor 35 due to defocusing of the photographing lens and/or due to various environmental factors previously described, an image can be captured with appropriate resolution by the photometric sensor 35. Accordingly, object recognition can be performed with high accuracy and stability.

Furthermore, in this embodiment, an aperture value at which object recognition can be achieved is found while the variable aperture 31 is stopped down stepwise, whereby the variable aperture 31 can be set to have a maximum aperture value among aperture values at which object recognition can be achieved. This makes it possible to perform the object recognition while preventing the brightness of light received by the photometric sensor 35 from being lowered due to stop-down of the variable aperture 31. This embodiment is the same as the first embodiment in other construction, function, and advantage.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment (s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-073047, filed Mar. 29, 2013, which is hereby incorporated by reference herein in its entirety.

What is claimed is:

1. An image pickup apparatus comprising:
a photometric unit configured to collect a light flux of an object image formed on a focusing screen, configured to measure the collected light flux to obtain photometric information that includes brightness information and image information about the object image, and configured to output the photometric information;
a variable photometric aperture disposed in an optical path along which a light flux from the focusing screen reaches said photometric unit, wherein said variable photometric aperture has a variable aperture diameter;
a photometric control unit configured to control said variable photometric aperture;
an object recognition unit configured to perform object recognition based on the image information output from said photometric unit; and
a determination unit configured to determine whether object recognition can be achieved by said object recognition unit based on an object recognition operation performed by said object recognition unit,
wherein in a case where said determination unit determines that object recognition cannot be achieved by said object recognition unit, said photometric control unit controls to stop down said variable photometric aperture.

2. The image pickup apparatus according to claim 1, wherein in a case where said determination unit determines that object recognition cannot be achieved by said object recognition unit, said photometric control unit acquires the brightness information output from said photometric unit, calculates an aperture value based on the acquired brightness information, and controls said variable photometric aperture to attain the calculated aperture value.

3. The image pickup apparatus according to claim 2, wherein said photometric control unit calculates the aperture value that falls within a photometry range where a brightness lower limit of said photometric unit is not exceeded.

4. The image pickup apparatus according to claim 1, wherein in a case where said determination unit determines that object recognition cannot be achieved by said object recognition unit, said photometric control unit controls to gradually stop down said variable photometric aperture until said determination unit determines that object recognition can be achieved by said object recognition unit.

5. The image pickup apparatus according to claim 1, further including:
a storage unit configured to store correction amounts corresponding to aperture values; and
a correction unit configured, when said variable photometric aperture is stopped down, to correct the photometric information output from said photometric unit by a corresponding one of the correction amounts stored in said storage unit.

6. The image pickup apparatus according to claim 1, further including:
a finder optical system configured to be used to observe the object image formed on the focusing screen,
wherein the light flux of the object image formed on the focusing screen is guided to said photometric unit via an optical path different from an optical path for guiding the light flux of the object image to said finder optical system.

7. An image pickup apparatus comprising:
a first imaging unit;
a second imaging unit different from said first imaging unit;
a reflection part configured to reflect a light flux entering through a photographing lens and traveling toward said first imaging unit and guide the reflected light flux to said second imaging unit;
an aperture disposed in an optical path for guiding the light flux reflected by said reflection part to said second imaging unit, and having an adjustable opening diameter; and
an aperture control unit configured to control the opening diameter of said aperture based on an image signal output from said second imaging unit.

8. The image pickup apparatus according to claim 7, further comprising:
an acquisition unit configured to acquire a photometric value based on the image signal output from said second imaging unit.

9. The image pickup apparatus according to claim 7, further comprising:
an object detection unit configured to perform object detection based on the image signal output from said second imaging unit.

10. The image pickup apparatus according to claim 9, wherein said aperture control unit controls the opening diameter of said aperture based on a result of detection by said object detection unit.

11. The image pickup apparatus according to claim 9, wherein when object detection is performed by said object detection unit based on the image signal output from said second imaging unit in a state that the opening diameter of said aperture is set to a first opening diameter but an object cannot be detected, said aperture control unit controls the opening diameter of said aperture to have a second opening diameter smaller than the first opening diameter.

12. The image pickup apparatus according to claim 11, further comprising:
an acquisition unit configured to acquire a photometric value based on the image signal output from said second imaging unit; and
a calculation unit configured to calculate the second opening diameter based on the photometric value acquired by said acquisition unit.

13. The image pickup apparatus according to claim 12, wherein said calculation unit calculates the second opening diameter such that the photometric value acquired by said acquisition unit based on the image signal output from said second imaging unit in a state that the opening diameter of said aperture is set to the second opening diameter does not become lower than a threshold value.

14. The image pickup apparatus according to claim 13, wherein the threshold value is a photometrically measurable lower limit value.

15. The image pickup apparatus according to claim 12, further comprising:
a correction unit configured to correct the photometric value acquired by said acquisition unit based on the opening diameter of said aperture.

16. The image pickup apparatus according to claim 15, wherein said correction unit corrects, by using a correction amount corresponding to a difference between the first and second opening diameters, the photometric value acquired by said acquisition unit based on the image signal output from said second imaging unit in a state that the opening diameter of said aperture is set to the second opening diameter.

17. The image pickup apparatus according to claim 15, wherein an exposure value at a time of imaging by said first imaging unit is decided based on the photometric value acquired by said acquisition unit or based on the photometric value corrected by said correction unit.

18. The image pickup apparatus according to claim 15, wherein in a case where object detection is performed by said object detection unit but an object cannot be detected, said aperture control unit sets the opening diameter of said aperture to a one-stage smaller opening diameter.

19. The image pickup apparatus according to claim 7, wherein said second imaging unit is disposed at a position different from on a primary imaging face of the photographing lens.

20. The image pickup apparatus according to claim 7, wherein said aperture is different from a second aperture disposed in an optical path for a light flux before reflected by said reflection part.
